(19) United States
(12) Patent Application Publication
(10) Pub. No.: US 2016/0225516 A1
(43) Pub. Date: Aug. 4, 2016

(54) SURFACE-MOUNT INDUCTOR AND A METHOD FOR MANUFACTURING THE SAME

(71) Applicant: TOKO, INC., Tsurugashima-shi (JP)

(72) Inventor: Kazuhisa KITAMURA, Tsurugashima-shi (JP)

(21) Appl. No.: 15/007,385

(22) Filed: Jan. 27, 2016

(30) Foreign Application Priority Data
Jan. 30, 2015 (JP) 2015-016642

(51) Int. Cl. H01F 27/29; H01F 41/04; H01F 27/28

(52) U.S. Cl. CPC H01F 27/292; H01F 27/2804; H01F 41/041

(57) ABSTRACT

A surface-mount inductor, having a coil formed by winding an insulated wire, and a mounting body incorporating the coil where the coil has lead ends, which are extended over the mounting face of the mounting body, the mounting face has a recessed portion formed by removing insulation of the lead ends, and the recessed portion is filled with sealant to make the mounting face of the mounting body flat, as well as a method for manufacturing the same are herein disclosed.

### CROSS REFERENCE TO RELATED APPLICATION

This application is based upon and claims the benefit of priority from the prior Japanese Patent Application No. 2015-016642, filed on Jan. 30, 2015, the entire contents of which are incorporated herein by reference.

### BACKGROUND OF THE INVENTION

1. Field of the Invention

The present invention relates to a surface-mount inductor and a method for manufacturing the same.

2. Description of the Related Art

Conventionally, surface-mount inductors whose coils have been coated with thermoplastic sealants (molding materials) containing magnetic powder and resin are widely used. For example, JP2003-290992 discloses a method for manufacturing surface-mount inductors using metal pieces as external terminals. The surface-mount inductors have external terminals which are metal pieces welded to lead ends to be processed to serve as external terminals. In an abovementioned surface-mount inductor, since its coil ends are welded to metal pieces, the contact portions of the coil ends and of the metal pieces are exposed to thermal and mechanical stresses. In addition, the mounting surfaces are not flat, since they are fitted with metal pieces.

### SUMMARY OF THE INVENTION

### Problem to Be Solved by the Invention

In this context, the present invention aims to provide a surface-mount inductor which has a mounting face of significant flatness and decreased thermal and mechanical stresses applied to the coil, as well as a method for manufacturing the same.

### Means for Solving the Problem

The surface-mount inductor according to the present invention, having a coil formed by winding an insulated wire and a mounting body incorporating the coil, wherein the coil has lead ends, the lead ends including a recessed portion which is formed by removing insulation of the lead ends, the recessed portion being filled with metal so as to flatten a mounting face of the mounting body.

### Effect of the Invention

In accordance with the surface-mount inductor according to the present invention, the lead ends are processed to be external terminals so that the thermal and mechanical stresses applied to the coil are decreased. Further, since the recessed portion of the mounting face, which is formed by removal of the insulation layer, is filled with metal, the mounting face is considerably flattened.

The method for manufacturing the surface-mount inductor of the present invention allows the efficient manufacturing of the abovementioned surface-mount inductors.

Thus, according to the present invention, a surface-mount inductor able to decrease the thermal and mechanical stresses applied to the coil and having a mounting face of high flatness, as well as a method for manufacturing the same are provided.

### BRIEF DESCRIPTION OF THE DRAWINGS

FIG. 1 is a perspective view of a coil used in a surface-mount inductor according to a first embodiment of the present invention;

FIG. 2 is a perspective view of blocks used in the face-mount inductor according to the first embodiment of the present invention;

FIG. 3 is a plan view of blocks used in the surface-mount inductor according to the first embodiment of the present invention;

FIGS. 4A, 4B and 4C show the method for manufacturing the surface-mount inductor according to the first embodiment of the present invention, FIG. 4A showing the state of the blocks before fitting, FIG. 4B showing the state of the blocks after fitting, and FIG. 4C showing the state of the mounting face after fitting the blocks;

FIG. 5 shows a step for manufacturing a mounting body of the surface-mount inductor according to the first embodiment of the present invention;

FIGS. 6A through 6D show steps for producing external terminals using lead ends after the step of FIG. 5;

FIG. 7 is a perspective view of the magnetic cores used in the surface-mount inductor according to the second embodiment of the present invention; and

FIG. 8 is a perspective view of the surface-mount inductor according to the second embodiment of the present invention.

### DETAILED DESCRIPTION OF THE INVENTION

### Embodiment 1

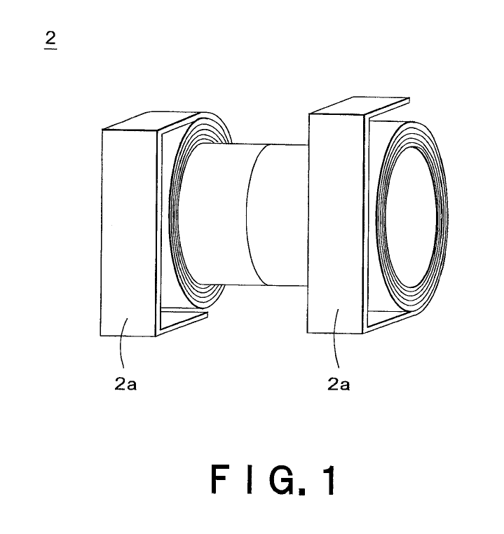

The first embodiment according to the present invention is described below in reference to FIGS. 1-6.

FIG. 1 is a perspective view of a coil used in a surface-mount inductor according to the first embodiment of the present invention. The coil 2 is formed by winding a rectangular wire, contacting its wide face to the winding axis of the winding machine (not shown) and processing the ends of the rectangular wire to form lead ends 2a.

As shown in FIG. 1, the coil 2 used in the surface-mount inductor according to the present invention is made of a rectangular wire, having first rolls which are wound in a two-roll arrangement on the winding axis of a winding machine, second rolls positioned away from the first rolls in opposite directions along the winding axis and wound, and lead ends 2a brought out from the second rolls. The lead ends 2a are respectively pulled to opposite sides of a radial direction, and the ends are arranged in a U-shaped profile (side view) surrounding the outer periphery of the coil 2.

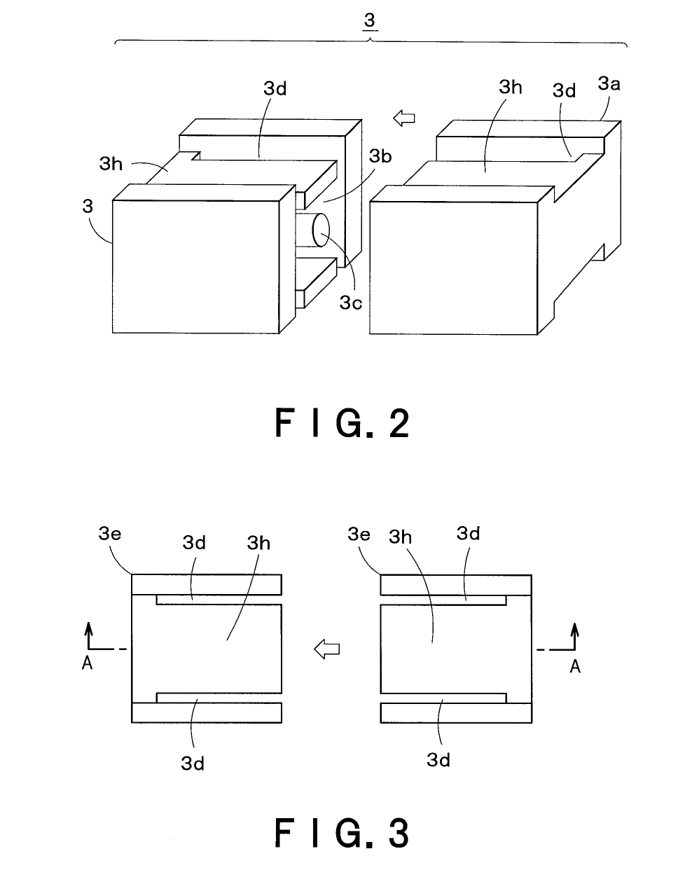

The mounting body is described in reference to FIG. 2. FIG. 2 is a perspective view of the blocks used in the surface-mount inductor according to the present invention.

As shown in FIG. 2, the mounting body 3 is formed by joining two blocks 3a. The blocks 3a are formed by thermopressing sealant which includes filler having magnetic metal powder, and epoxy resin. The shape of the formed blocks 3a is a rectangular parallelepiped having a space inside for accommodating the coil 2. The block 3a has an aperture at one end and both ends are connected with the upper and bottom and side surfaces. The blocks 3a have a space 3b for accommodating the coil 2, and a cylindrical protrusion 3c inside. The protrusion 3c is provided on the end surface opposite to the other end surface having the aperture, and extends toward the aperture.

At the side portions of the upper and the bottom surfaces of the blocks 3a, two slits 3d extending along the side surfaces are provided. The slits 3d are terminated at one of the end surfaces, and are opened at the other end surface having the aperture.

The upper and bottom surfaces of the blocks 3a are the same shape, any one of them being the mounting face 3e. In this embodiment, the upper surface serves as the mounting face 3e.

FIG. 3 is a plan view of the mounting faces 3e of the blocks 3a, the blocks 3a being used in the surface-mount inductor according to the present invention. As shown in FIG. 3, the outline of the mounting face 3e is a rectangle, with a side at the aperture end surface being its short side and a side perpendicular to the short side being its a long side.

The portion between the two slits 3d, arranged on the mounting face 3e, is a supporting portion 3h for supporting the lead ends 2a of the coil 2. The two slits 3d and the supporting portion 3h form a U-shaped structure.

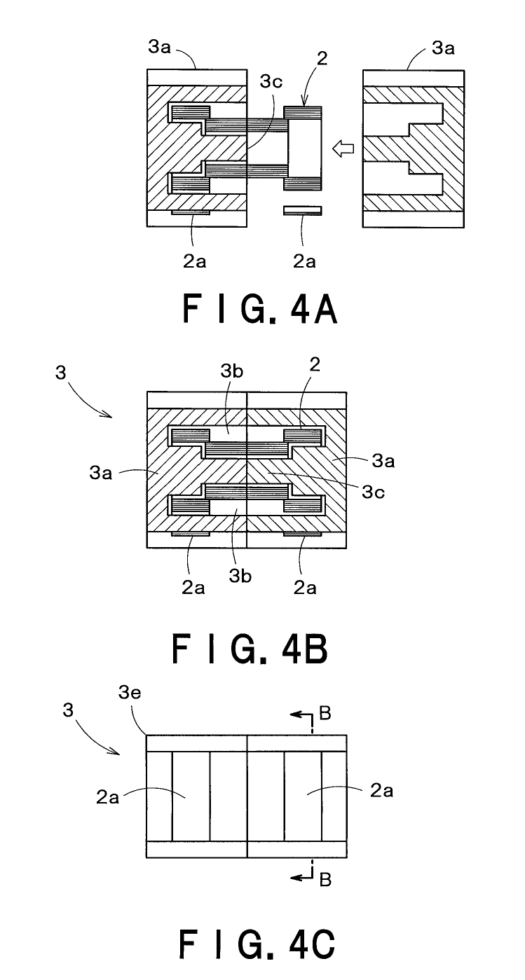

The method for sealing the coil 2 in the mounting body 3 is described in reference to FIGS. 4A-4C. FIGS. 4A and 4B are sectional views of the section A-A in FIG. 3, and FIG. 4C is a plan view of the mounting face 3e.

As shown in FIG. 4A, the blocks 3a are arranged on both sides in the winding axis direction of the coil 2, the ends which have the aperture being opposite to each other. The protrusion 3c of one of the blocks 3a is inserted into the central hole of the coil 2. The lead ends 2a are pulled out through the slits 3d.

FIG. 4B shows the state of the protrusion 3c of the other block 3a being inserted into the central hole of the coil 2 to join the blocks 3a. Since the blocks 3a are provided with the space 3b inside, the coils 2 are accommodated in the two blocks 3a in such a manner that the protrusions 3c are inserted into the central holes.

The lead ends 2a of the coil 2 are brought out through the slits 3d onto the supporting portion 3h at one side and then inserted into the slits 3d at the other side. The lead ends 2a form a U-shaped structure around the outer periphery of the coil 2 and the supporting portion 3h.

The two blocks 3a accommodating the coil 2 are inserted into a mold. Then, the sealant of the blocks 3a is thermopressed to be softened and shaped to form the mounting body 3. As shown in FIG. 4C, the lead ends 2a are embedded in and fixed to the mounting body 3 with surfaces being exposed. As a result, the two blocks 3a form the mounting body 3 which accommodates the coil 2 inside.

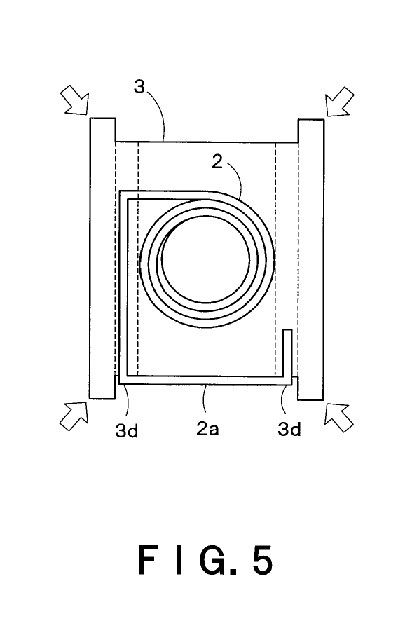

FIG. 5 shows the section B-B in FIG. 4C, and is a sectional view showing the step of forming the mounting body 3 in the surface-mount inductor according to the first embodiment of the present invention.

The mounting body 3 is softened and shaped through thermopressing as described above. In the step, since the mounting body 3 is compressed inwardly as shown by arrows in FIG. 5, the four corners receive considerable deforming pressure to push sealant toward the center of the coil 2. Thus, the protrusions at the four corners are crushed to make the mounting body 3 round.

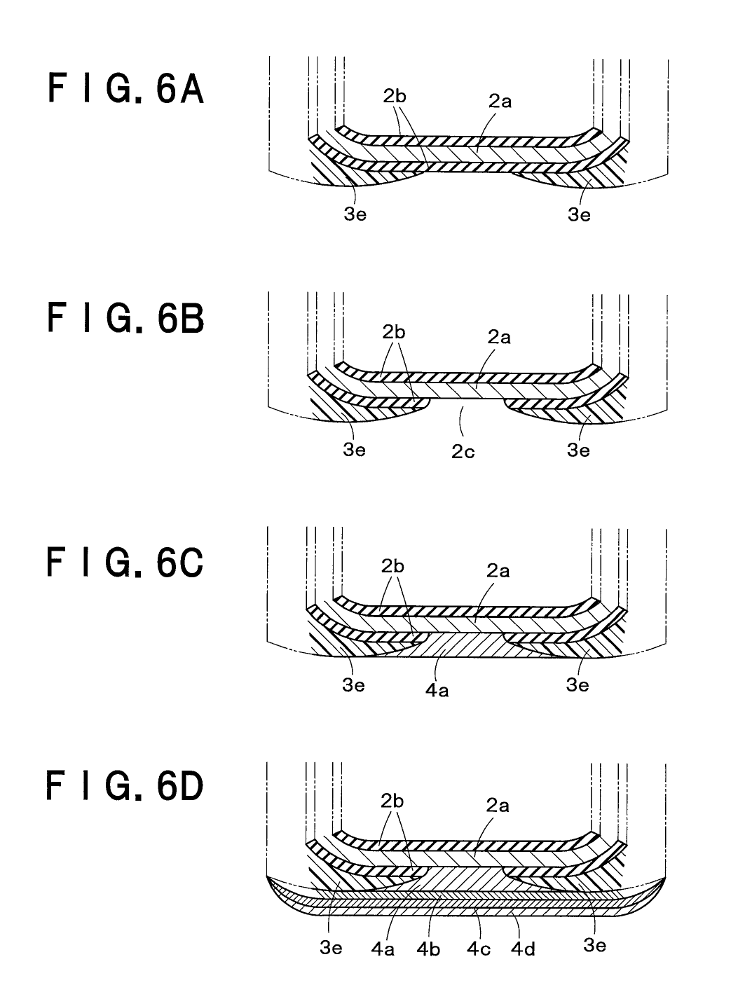

FIGS. 6A through 6D show the steps for forming outer terminals using the lead ends after the step of FIG. 5. FIGS. 6A through 6D show the lower ends of the mounting body 3 in FIG. 5, namely the portion around the lead ends 2a brought out from the coil 2.

In FIG. 6A, the lead ends 2a are covered with the insulation cover 2b, the exposed surface thereof being the insulation cover 2b. Then, the insulation cover 2b is removed by laser irradiation in order to expose the lead ends 2a. FIG. 6B shows the state wherein the metal of the lead ends 2a is exposed after the removal of the insulation cover, and a recessed portion 2c is formed.

Next, as shown in FIG. 6C, a Sn layer 4a is formed by filling the recessed portion 2c with Sn. Thus, the lower surface between the mounting surfaces 3e of the mounting body 3 is filled with the Sn layer to form a substantially flat surface.

The flat surface is, as shown in FIG. 6D, overlaid with three metal layers, that is, a Ag layer 4b, a Ni layer 4c and a Sn layer 4d so as to form a metal layer having a flat surface which crosses the lower surface of the mounting body 3. The metal layer functions as the external terminal of the surface-mount inductor.

Through the steps abovementioned, a surface-mount inductor having a flat mounting surface is formed. The means for removing the insulation cover are not restricted to laser.

### Embodiment 2

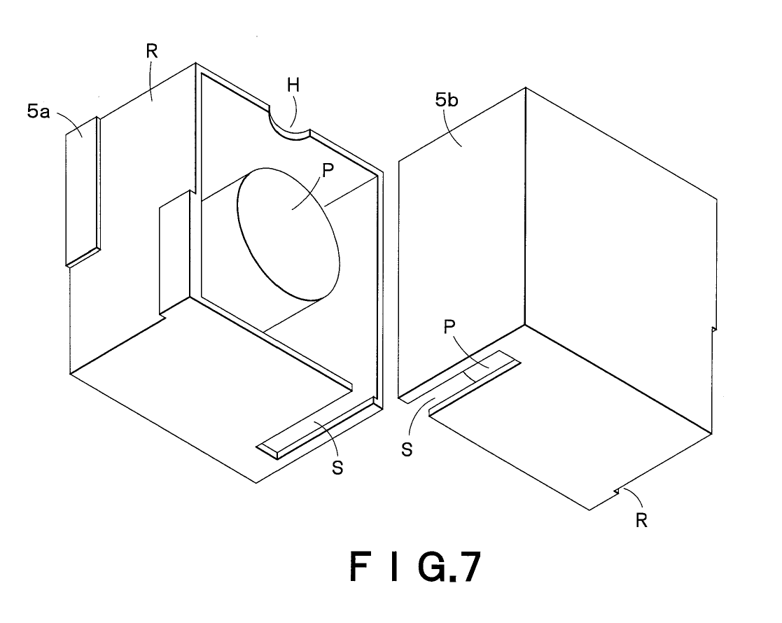

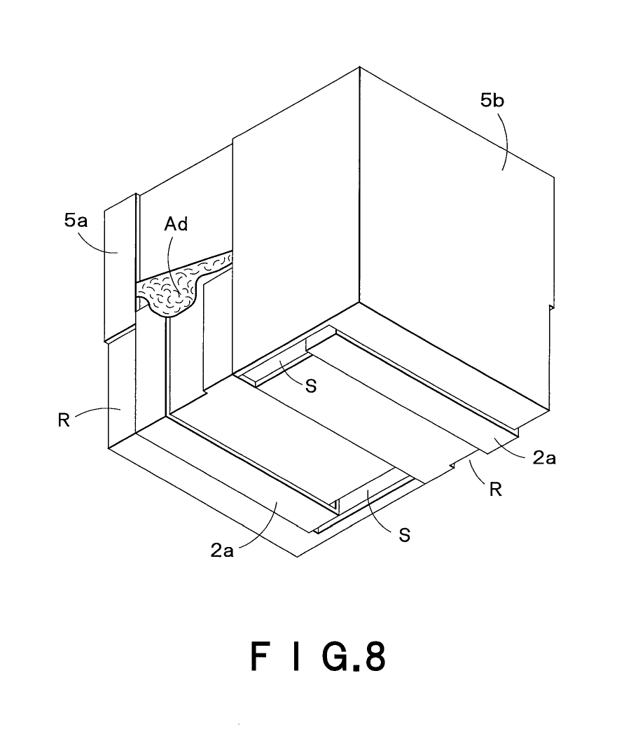

The second embodiment of the surface-mount inductor and the method for manufacturing the same according to the second embodiment of the present invention are described in reference to FIGS. 7 and 8. The second embodiment regards a surface-mount inductor, having a mounting body which consists of magnetic cores and sealant, and accommodates a coil. FIG. 7 is a perspective view of the magnetic cores used in the surface-mount inductor according to the second embodiment of the present invention. FIG. 8 is a perspective view of the surface-mount inductor according to the second embodiment of the present invention.

At first, the coil 2 (FIG. 1) is formed through a method similar to that of the first embodiment. Then, as shown in FIG. 7, a pair of bottomed magnetic cores 5a, 5b, each of which includes a protrusion P to be inserted into the central hole of the coil 2, a slit S for pulling out the lead ends 2a to the mounting face 3e, a hole H provided at the aperture side of the surface opposite to the mounting face, and a recessed portion R, is attached to the coil 2.

The pair of bottomed magnetic cores 5a, 5b is attached to the coil 2 in such a manner that the protrusion P is inserted into the central hole of the coil 2 from both sides in the winding axis direction, and the lead ends 2a are inserted into the slits S. Thus, the coil 2 is accommodated in the pair of bottomed magnetic cores 5a, 5b.

Subsequently, as shown in FIG. 8, the lead ends 2a of the coil 2 are bent along the surfaces of the magnetic cores 5a, 5b to extend over the mounting faces 3e of the pair of the bottomed magnetic cores 5a, 5b and the surfaces adjacent to the mounting faces 3e.

The portions of the lead ends 2a extending over the surfaces are bent upward from the mounting faces 3e, and arranged in the recessed portion R formed on the neighboring surfaces.

Then, the ends of the lead ends 2a arranged in the recessed portion R, which is formed on a neighboring surface, are fixed thereto by means of adhesive Ad as shown in FIG. 8.

Further, the magnetic cores 5a, 5b having the coil inside are arranged in a mold directing the mounting faces 3e upside, and the mold is filled with sealant (molding resin). The sealant is filled thereto ensuring that the lead ends, which are brought out to the mounting faces of the magnetic cores 5a, 5b, are exposed.

Since the magnetic cores 5a, 5b have slits S and a hole H, the sealant fully reaches inside of the magnetic cores 5a, 5b, and the sealant is filled up to the same level as the mounting faces.

Next, as the resin is left to solidify and the molded body is taken out from the mold, a mounting body 3 with the lead ends 2a exposed is obtained, and the lead ends 2a extending over the surfaces adjacent to the mounting face 3e are sealed with sealant. External terminals are formed in a similar way to that of the first embodiment, using the lead ends 2a of the coil 2.

The scope of the present invention should not be limited to the embodiments described above. For example, a part of the blocks may be substituted by magnetic cores, and vice versa, a part of the magnetic cores may be substituted by the blocks. Further, the mounting faces of the magnetic cores may be covered with sealant so as to expose the surfaces of the lead ends. Furthermore, ferrite may be mixed in the sealant.

### EXPLANATION OF CODES

1 surface-mount inductor
2 coil
2a lead end
2b insulation cover
2c recessed portion
3 mounting body
3a block
3b space
3c protrusion
3d slit
3e mounting face
3h supporting portion
4 external terminal
4a, 4d Sn layer
4b Ag layer
4c Ni layer
5a, 5b magnetic core
P protrusion
S slit
H hole
R recessed portion
Ad adhesive

What is claimed is:

1. A surface-mount inductor having a coil made by winding an insulated wire, and a mounting body accommodating the coil inside, wherein
the coil has lead ends,
the lead ends extend over a mounting face of the mounting body,
the mounting face of the mounting body has a recessed portion formed by removing insulation from the lead ends, and
the recessed portion is filled with metal so that the mounting face of the mounting body are flat.

2. The surface-mount inductor according to claim 1, wherein
the recessed portion is filled with a metal layer consisting of a combination of an Sn layer, an Ag layer and a Ni layer.

3. A method for manufacturing a surface-mount inductor having a coil made by winding an insulated wire, and a mounting body accommodating the coil inside, comprising the steps of:
forming a coil;
incorporating the coil in the mounting body and extending lead ends of the coil over the mounting face of the mounting body;
removing insulation from the lead ends; and
filling a recessed portion, formed by removing insulation from the lead ends, with metal to form a surface to be level with the mounting face of the mounting body so as to make external terminals.
